(19) United States
(12) Patent Application Publication
(10) Pub. No.: US 2016/0311967 A1
(43) Pub. Date: Oct. 27, 2016

(54) EPOXY RESIN, METHOD FOR PRODUCING THE SAME, EPOXY RESIN COMPOSITION, AND CURED PRODUCT THEREOF

(71) Applicant: DIC Corporation, Tokyo (JP)

(72) Inventors: Yasuyo YOSHIMOTO, Sakura-shi (JP); Hiroshi KINOSHITA, Sakura-shi (JP)

(21) Appl. No.: 15/105,176

(22) PCT Filed: Dec. 16, 2014
(86) PCT No.: PCT/JP2014/083214

§ 371 Date: Jun. 16, 2016

(30) Foreign Application Priority Data
Dec. 19, 2013 (JP) 2013-262462

(51) Int. Cl. C08G 59/32; C08L 63/00

(52) U.S. Cl. CPC C08G 59/3218; C08L 63/00

(57) ABSTRACT

The present invention relates to an epoxy resin containing a biphenyl skeleton, a method for producing the epoxy resin, an epoxy resin composition containing a biphenyl skeleton, and a cured product thereof. More particularly, the present invention relates to an epoxy resin being a compound having a 3,3′,5,5′-tetraglycidyloxy biphenyl skeleton, and to an epoxy resin composition containing the epoxy resin. The present invention also relates to a method for producing an epoxy resin including causing a compound having a 3,3′,5,5′-tetrahydroxy biphenyl skeleton to react with epihalohydrin, and to an epoxy resin obtained by the production method.

### TECHNICAL FIELD

The present invention relates to an epoxy resin containing a biphenyl skeleton, a method for producing the epoxy resin, an epoxy resin composition containing a biphenyl skeleton, and a cured product thereof.

### BACKGROUND ART

Polyhydric compounds and epoxy resins formed from polyhydric compounds provide cured products having low curing shrinkage (high dimensional stability), good electrical insulation, good chemical resistance, and the like. In view of this, such polyhydric compounds and epoxy resins have been widely used for, for example, semiconductor encapsulating materials and electronic components such as printed circuit boards, electrically conductive adhesives, such as electrically conductive pastes, other adhesives, matrices for composite materials, paints, photoresist materials, and developers. With the recent trend toward downsizing and high-density packaging in the field of electronic components, the heat density remarkably increases. Therefore, epoxy resins, which are used in various components, need to have high heat resistance and low thermal expansion.

A tetrafunctional naphthalene-type epoxy resin described in PTL 1 is known as an epoxy resin material that meets the requirements of high heat resistance and low thermal expansion. The tetrafunctional naphthalene-type epoxy resin has a naphthalene skeleton with high heat resistance, has high crosslinking density because of its tetrafunctionality, and has a molecular structure with good symmetry properties compared with ordinary phenol novolac-type epoxy resins and ordinary bifunctional monomer-type epoxy resins. Consequently, the cured product of the tetrafunctional naphthalene-type epoxy resin has very good heat resistance and low thermal expansion. However, since the tetrafunctional naphthalene-type epoxy resin has high melt viscosity, such an epoxy resin raises concerns about wire deformation, void generation, and the like, and also reduces working efficiency, for example, in transfer molding in packaging material applications. Therefore, it would be desirable to reduce the viscosity.

Epoxy resins exhibiting crystalline properties at normal temperature, which are typified by a bifunctional biphenyl-type epoxy resin described in PTL 2, are solid resins and are known to have a viscosity as low as that of liquid resins when the epoxy resins are melted. However, these epoxy resins fail to have heat resistance as high as that of the tetrafunctional naphthalene-type epoxy resin described in PTL 1 because of their bifunctionality. Therefore, there is a need for an epoxy resin having a viscosity as low as that of liquid resins when the epoxy resin is melted, and having high heat resistance.

NPL 1 describes 2,2′,4,4′-tetraglycidyloxy biphenyl. However, this epoxy resin has low crystallinity and is a viscous liquid and thus results in low working efficiency. In general, cured products of amorphous epoxy resins are known to have lower heat resistance than those of crystalline epoxy resins having a similar structure that differs in the position of functional groups. The positions of functional groups on the biphenyl skeleton are important factors that affect crystallinity and the physical properties, such as heat resistance, of cured products. The terms representing tetrafunctional biphenyl-type epoxy resins, such as bisresorcinol tetraglycidyl ether and tetraglycidoxy biphenyl, are described in many patent documents including PTL 3 and PTL 4. However, none of these patent documents clearly specify the positions of functional groups on the biphenyl skeleton, which affect the properties of resins. That is, none of these patent documents describe specific compounds.

A 3,3′,5,5′-tetraglycidyloxy biphenyl skeleton has the most favorable molecular symmetry properties among a number of positional isomers having a tetrafunctional biphenyl skeleton. The 3,3′,5,5′-tetraglycidyloxy biphenyl skeleton achieves both low melt viscosity and good working efficiency because of its crystallinity, and further has small steric hindrance and thus forms a densely crosslinked structure because all of four functional groups are oriented in different directions. As a result, cured products thereof have good heat resistance. A 3,3′,5,5′-tetraglycidyloxy biphenyl-type epoxy resin of the present invention has not been synthesized so far and is a novel epoxy resin.

### CITATION LIST

### Patent Literature

PTL 1: Japanese Patent No. 3137202

PTL 2: Japanese Patent No. 3947490

PTL 3: Japanese Unexamined Patent Application Publication No. 02-160841

PTL 4: Japanese Unexamined Patent Application Publication No. 58-080317

### Non Patent Literature

NPL 1: Advances in Chemistry Series, 1970, 92,173-207

### SUMMARY OF INVENTION

### Technical Problem

An object of the present invention is to provide an epoxy resin composition that has crystalline properties and low melt viscosity and whose cured product exhibits good heat resistance and low thermal expansion, and to provide a cured product of the epoxy resin composition, a novel epoxy resin providing these properties, and a method for producing the epoxy resin.

### Solution to Problem

The inventors of the present invention have carried out diligent studies and as a result, have found that a 3,3′,5,5′-tetraglycidyloxy biphenyl-type epoxy resin has crystalline properties and low melt viscosity, and a cured product of the epoxy resin has good heat resistance and low thermal expansion, completing the present invention.

That is, the present invention relates to the following [1] to [5].

[1] An epoxy resin is a compound having a 3,3′,5,5′-tetraglycidyloxy biphenyl skeleton represented by formula (1) below.

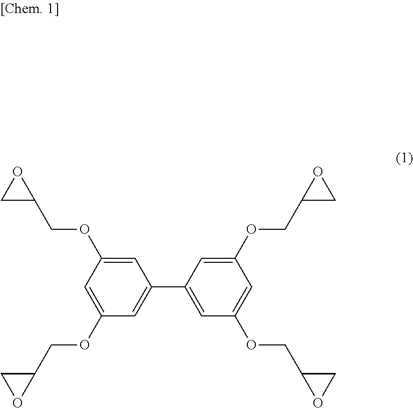 [SMILES: c1c(OCC2CO2)cc(-c2cc(OCC3CO3)cc(OCC3CO3)c2)cc1OCC1CO1]

[2] A method for producing an epoxy resin includes causing a compound having a 3,3′,5,5′-tetrahydroxy biphenyl skeleton to react with epihalohydrin.

[3] An epoxy resin is obtained by the production method according to [2] above.

[4] An epoxy resin composition includes the epoxy resin according to [1] to [3] above and a curing agent or a curing accelerator.

[5] A cured product is formed by curing the epoxy resin composition according to [4] above.

### Advantageous Effects of Invention

The present invention can provide a tetrafunctional biphenyl skeleton-containing epoxy resin having low melt viscosity, and a method for producing the epoxy resin. A cured product of the epoxy resin exhibits good heat resistance and low linear expansion.

### BRIEF DESCRIPTION OF DRAWINGS

FIG. 1 is a GPC chart of 3,3′,5,5′-tetraglycidyloxy biphenyl obtained in Example 1.

FIG. 2 is a C¹³ NMR chart of 3,3′,5,5′-tetraglycidyloxy biphenyl obtained in Example 1.

FIG. 3 is an MS chart of 3,3′,5,5′-tetraglycidyloxy biphenyl obtained in Example 1.

### DESCRIPTION OF EMBODIMENTS

The present invention will be described below in detail. An epoxy resin of the present invention can be obtained by, for example, a method of the present invention including causing a compound having a 3,3′,5,5′-tetrahydroxy biphenyl skeleton to react with epihalohydrin. Specifically, the epoxy resin is represented by structural formula (1) below.

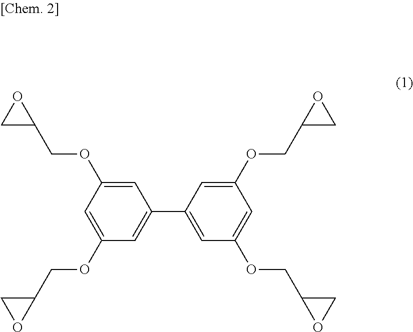 [SMILES: c1c(OCC2CO2)cc(-c2cc(OCC3CO3)cc(OCC3CO3)c2)cc1OCC1CO1]

In formula (1), the biphenyl skeleton may optionally have a substituent. Examples of the substituent, if present, include halogen groups and hydrocarbon groups. The hydrocarbon groups are optionally substituted hydrocarbon groups having 1 to 10 carbon atoms. Examples of the hydrocarbon groups include alkyl groups, such as a methyl group, an ethyl group, an isopropyl group, and a cyclohexyl group; alkenyl groups, such as a vinyl group, an allyl group, and a cyclopropenyl group; alkynyl groups, such as an ethynyl group and a propynyl group; aryl groups, such as a phenyl group, a tolyl group, a xylyl group, and a naphthyl group; and aralkyl groups, such as a benzyl group, a phenethyl group, and a naphthyl methyl group. The substituent may be any substituent that has no significant effect during production of the epoxy resin of the present invention. In order to reduce the melt viscosity of the epoxy resin, long-chain alkyl groups, alkenyl groups, and alkynyl groups, which have high mobility, are preferred. However, a substituent having high mobility reduces the heat resistance of epoxy resin-cured products. Therefore, the epoxy resin of the present invention preferably has no substituent or has a hydrocarbon group having 1 to 4 carbon atoms; more preferably has no substituent or has a methyl group or an allyl group; and still more preferably has a symmetrical structure when having substituents.

The compound having the 3,3′,5,5′-tetrahydroxy biphenyl skeleton, which is a material of the epoxy resin of the present invention, may be a by-product of resorcinol production, or may be intentionally produced by using a publicly known method. Examples of the method for intentionally synthesizing the compound having the 3,3′,5,5′-tetrahydroxy biphenyl skeleton include homocoupling reactions of resorcinol or halogenated resorcinol, silane derivatives, tin derivatives, lithium derivatives, boronic acid derivatives, sulfonic acid derivatives such as trifluoromethanesulfonic acid, and the like; and heterocoupling reactions in combination of any two compounds selected from resorcinol or halogenated resorcinol, silane derivatives, tin derivatives, lithium derivatives, boronic acid derivatives, sulfonic acid derivatives such as trifluoromethanesulfonic acid, alkoxy derivatives, magnesium halide derivatives, zinc halide derivatives, and the like. Of the coupling reactions described above, coupling reactions, such as the Ullmann reaction (Ullmann, F, J. Chem. Ber. 1901, 34, 2174) and the Suzuki coupling reaction (J. Organomet. Chem., 576, 147 (1999); Synth. Commun., 11, 513 (1981)), which use metal catalysts, such as copper and palladium, are simple and provide high yield. Furthermore, the positions of functional groups are limited to the 3,3′,5,5′-positions in the formation of the biphenyl skeleton, and multimerization does not occur. As a result, a high-purity compound having the 3,3′,5,5′-tetrahydroxy biphenyl skeleton can be obtained. Causing this compound to react with epihalohydrin provides a high-purity epoxy resin having crystalline properties and low melt viscosity.

The method for producing the epoxy resin of the present invention is any publicly known method. Examples of the method include a production method in which a compound having the 3,3′,5,5′-tetrahydroxy biphenyl skeleton reacts with epihalohydrin, and a production method in which a compound having the 3,3′,5,5′-tetrahydroxy biphenyl skeleton reacts with an allyl halide to form an allyl ether, followed by an oxidation reaction. The production method in which a compound having the 3,3′,5,5′-tetrahydroxy biphenyl skeleton reacts with epihalohydrin is industrially advantageous. An example of the production method is described below in detail.

In an example production method in which a phenolic compound reacts with epihalohydrin, specifically, epihalohydrin is added in an amount of 2 to 10 times (on a molar basis) the number of moles of the phenolic hydroxyl group in the phenolic compound, and a basic catalyst is further added at once or gradually in an amount of 0.9 to 2.0 times (on a molar basis) the number of moles of the phenolic hydroxyl group, during which the reaction proceeds at a temperature of 20° C. to 120° C. for 0.5 to 10 hours. This basic catalyst may be in the form of a solid or an aqueous solution. When an aqueous solution is used, the following method may be employed: continuously adding the aqueous solution of the basic catalyst while continuously distilling water and epihalohydrin off from the reaction mixture under reduced pressure or normal pressure; further separating water and epihalohydrin; and removing water while continuously returning epihalohydrin to the reaction mixture.

In industrial production, epihalohydrin used for preparation in the first batch in epoxy resin production is all fresh, whereas epihalohydrin used for preparation in the subsequent batches may be a combination of epihalohydrin recovered from the crude reaction product and fresh epihalohydrin in an amount corresponding to the consumption or the loss during the reaction, which is economically preferred. Examples of the epihalohydrin used herein include, but are not limited to, epichlorohydrin, epibromohydrin, and β-methylepichlorohydrin. In particular, epichlorohydrin is preferred because of its industrial availability.

Specific examples of the basic catalyst include alkaline earth metal hydroxides, alkali metal carbonates, and alkali metal hydroxides. In particular, the basic catalyst is preferably an alkali metal hydroxide because of its high catalytic activity in the epoxy resin synthesis reaction. Examples of the alkali metal hydroxide include sodium hydroxide and potassium hydroxide. These basic catalysts may be used in the form of an aqueous solution containing about 10 to 55 mass % of the basic catalyst or may be used in the form of a solid. In this case, a phase transfer catalyst, such as a quaternary ammonium salt or a crown ether, may be present for the purpose of increasing the reaction rate. The amount of the phase transfer catalyst, when used, is preferably 0.1 to 3.0 parts by mass based on 100 parts by mass of the epoxy resin used. When an organic solvent is used in combination, the reaction rate in the synthesis of the epoxy resin increases. Examples of the organic solvent include, but are not limited to, ketones, such as acetone, methyl ethyl ketone; alcohols, such as methanol, ethanol, 1-propyl alcohol, isopropyl alcohol, 1-butanol, sec-butanol, and tert-butanol; Cellosolve, such as methyl Cellosolve and ethyl Cellosolve; ethers, such as tetrahydrofuran, 1,4-dioxane, 1,3-dioxane, and diethoxyethane; and aprotic polar solvents, such as acetonitrile, dimethyl sulfoxide, and dimethylformamide. These organic solvents may be used alone or may be appropriately used in combination of two or more in order to control polarity.

After the reaction product in the above epoxidation reaction is washed with water, unreacted epihalohydrin and an organic solvent used in combination are distilled off by performing heating under reduced pressure. Furthermore, in order to obtain an epoxy resin having a small hydrolyzable halogen content, the obtained epoxy resin may be redissolved in an organic solvent, such as toluene, methyl isobutyl ketone, or methyl ethyl ketone, and an aqueous solution of an alkali metal hydroxide, such as sodium hydroxide or potassium hydroxide, may be added to cause further reaction. In this case, a phase transfer catalyst, such as a quaternary ammonium salt or a crown ether, may be present for the purpose of increasing the reaction rate. The amount of the phase transfer catalyst, when used, is preferably 0.1 to 3.0 parts by mass based on 100 parts by mass of the epoxy resin used. After the reaction is complete, a formed salt is removed by, for example, filtration and washing with water, and the solvent, such as toluene or methyl isobutyl ketone, is distilled off by performing heating under reduced pressure. As a result, a desired novel epoxy resin of the present invention can be obtained.

In the method for producing an epoxy resin of the present invention, the compound having the 3,3′,5,5′-tetrahydroxy biphenyl skeleton may be caused to react with epihalohydrin using another polyphenol in combination unless advantageous effects of the present invention are impaired.

Next, an epoxy resin composition of the present invention contains the novel epoxy resin described above in detail. The epoxy resin composition preferably contains a curing agent or a curing accelerator. The epoxy resin may be a reaction product containing oligomer components in the production of the epoxy resin.

The curing agent used herein is any compound that is generally used as a curing agent for ordinary epoxy resins. Examples of the curing agent include amine compounds, amide compounds, acid anhydride compounds, and phenolic compounds. Specific examples of amine compounds include diaminodiphenylmethane, diethylenetriamine, triethylenetetramine, diaminodiphenyl sulfone, isophoronediamine, imidazole, BF3-amine complexes, and guanidine derivatives. Specific examples of amide compounds include dicyandiamide and polyamide resins synthesized from linolenic acid dimer and ethylenediamine. Specific examples of acid anhydride compounds include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride. Specific examples of phenolic compounds include polyhydric phenol compounds, such as phenol novolac resins, cresol novolac resins, aromatic hydrocarbon formaldehyde resin-modified phenolic resins, dicyclopentadiene phenol adduct resins, phenol aralkyl resin (Xylok resin), polyphenol novolac resins synthesized from polyhydric compounds and formaldehyde, which is typified by resorcin novolac resins, naphthol aralkyl resins, trimethylolmethane resins, tetraphenylolethane resins, naphthol novolac resins, naphthol-phenol co-condensed novolac resins, naphthol-cresol co-condensed novolac resins, biphenyl-modified phenolic resins (polyhydric phenol compounds in which phenol nuclei are linked to each other through bismethylene groups), biphenyl-modified naphthol resins (polyhydric naphthol compounds in which naphthol nuclei are linked to each other through bismethylene groups), aminotriazine-modified phenolic resins (polyhydric phenol compounds in which phenol nuclei are linked to each other by melamine, benzoguanamine, and the like through methylene bonding), and alkoxy group-containing aromatic ring-modified novolac resins (polyhydric phenol compounds in which phenol nuclei and alkoxy group-containing aromatic rings are linked thorough formaldehyde). These curing agents may be used alone or in combination of two or more.

The amounts of the epoxy resin and the curing agent in the epoxy resin composition of the present invention are preferably, but not necessarily, such that the amount of the active group in the curing agent is 0.7 to 1.5 equivalents per equivalent of the total epoxy group in the epoxy resin because the resultant cured product has desired properties.

Various curing accelerators can be used as the curing accelerator. Examples of the curing accelerator include phosphorus compounds, tertiary amines, imidazole, organic acid metal salts, Lewis acids, and amine complex salts.

In the epoxy resin composition of the present invention, the epoxy resin of the present invention may be used alone as an epoxy resin component. If desired, the epoxy resin of the present invention may be used in combination with another publicly known epoxy resin. Examples of the other epoxy resin include, but are not limited to, bisphenol epoxy resins, such as bisphenol A epoxy resin and bisphenol F epoxy resin; benzene epoxy resins, such as resorcinol diglycidyl ether epoxy resin and hydroquinone diglycidyl ether epoxy resin; biphenyl epoxy resins, such as tetramethyl biphenol epoxy resin and triglycidyloxy biphenyl epoxy resin; naphthalene epoxy resins, such as 1,6-diglycidyloxy naphthalene epoxy resin, 1-(2,7-diglycidyloxynaphthyl)-1-(2-glycidyloxynaphthyl)methane, 1,1-bis(2,7-diglycidyloxynaphthyl)methane, 1,1-bis(2,7-diglycidyloxynaphthyl)-1-phenyl-methane, and 1,1-bi(2,7-diglycidyloxynaphthyl); novolac epoxy resins, such as phenol novolac epoxy resins, cresol novolac epoxy resins, bisphenol A novolac epoxy resin, epoxides of condensates of phenols and phenolic hydroxyl group-containing aromatic aldehydes, biphenyl novolac epoxy resins, naphthol novolac epoxy resins, naphthol-phenol co-condensed novolac epoxy resins, and naphthol-cresol co-condensed novolac epoxy resins; aralkyl epoxy resins, such as phenol aralkyl epoxy resins and naphthol aralkyl epoxy resins; triphenylmethane epoxy resins; tetraphenylethane epoxy resins; dicyclopentadiene-phenol adduct epoxy resins; phosphorus-containing epoxy resins synthesized by using 10-(2,5-dihydroxyphenyl)-10H-9-oxa-10-phosphaphenanthrene-10-oxide or the like; fluorene epoxy resins; xanthene epoxy resins; aliphatic epoxy resins, such as neopentyl glycol diglycidyl ether and 1,6-hexanediol diglycidyl ether; alicyclic epoxy resins, such as 3,4-epoxycyclohexylmethyl-3,4-epoxycyclohexane carboxylate and bis-(3,4-epoxycyclohexyl)adipate; heterocycle-containing epoxy resins, such as triglycidyl isocyanurate; glycidyl ester epoxy resins, such as diglycidyl phthalate, diglycidyl tetrahydrophthalate, diglycidyl hexahydrophthalate, diglycidyl p-oxybenzoate, glycidyl dimerate, and triglycidyl esters; glycidyl amine epoxy resins, such as diglycidyl aniline, tetraglycidyl aminodiphenylmethane, triglycidyl-p-aminophenol, tetraglycidyl methaxylylenediamine, diglycidyl toluidine, and tetraglycidyl bisaminomethylcyclohexane; and hydantoin epoxy resins, such as diglycidyl hydantoin and glycidyl glycidoxyalkyl hydantoin. These epoxy resins may be used alone or in a mixture of two or more.

The epoxy resin composition of the present invention described in detail exhibits good solvent solubility. The epoxy resin composition thus may contain an organic solvent in addition to the above components. Examples of the organic solvent that may be used here include ketone solvents, such as acetone, methyl ethyl ketone, methyl isobutyl ketone, and cyclohexanone; acetate solvents, such as ethyl acetate, butyl acetate, Cellosolve acetate, propylene glycol monomethyl ether acetate, and Carbitol acetate; Carbitol solvents, such as Cellosolve and butyl Carbitol; aromatic hydrocarbon solvents, such as toluene and xylene; and amide solvents, such as dimethylformamide, dimethylacetamide, and N-methylpyrrolidone.

The epoxy resin composition of the present invention may further contain various publicly known additives, such as a filler, a colorant, a flame retardant, a release agent, and a silane coupling agent if desired.

Typical examples of the filler include silica, alumina, silicon nitride, aluminum hydroxide, magnesium oxide, magnesium hydroxide, boron nitride, and aluminum nitride. Typical examples of the colorant include carbon black. Typical examples of the flame retardant include antimony trioxide. Typical examples of the release agent include carnauba wax. Typical examples of the silane coupling agent include aminosilanes and epoxysilanes.

The epoxy resin composition of the present invention is obtained by uniformly mixing the above components. The epoxy resin composition of the present invention containing the epoxy resin of the present invention, a curing agent, and optionally a curing accelerator can be easily cured as in conventionally known methods to form a cured product. Examples of the cured product include formed cured products, such as laminates, castings, adhesive layers, coatings, and films.

The epoxy resin composition of the present invention can be used in applications, such as laminate resin materials, electrical insulating materials, semiconductor encapsulating materials, fiber-reinforced composite materials, coating materials, molding materials, and materials of electrically conductive adhesives and other adhesives.

The epoxy resin of the present invention, which is a compound having the 3,3′,5,5′-tetraglycidyloxy biphenyl skeleton, achieves both low melt viscosity and good working efficiency because of its crystallinity, and has small steric hindrance and thus forms a densely crosslinked structure because all of four functional groups are oriented in different directions. As a result, the cured product of the epoxy resin has good heat resistance and low thermal expansion in a high-temperature region.

Compared with tetrafunctional glycidyl ether of 1,1′-alkylenebis(2,7-dihydroxynaphthalene) obtained from the reaction product of dihydroxynaphthalene and formaldehyde described in Japanese Patent No. 3137202, the epoxy resin of the present invention has crystalline properties and its melt viscosity decreases from 4.5 dPas to 0.6 dPas, which is similar to the viscosity of liquid resins. Consequently, for example, working efficiency in transfer molding significantly increases, and an epoxy single molding can be formed using imidazole as a curing accelerator, which is difficult to achieve with tetrafunctional glycidyl ether of 1,1′-alkylenebis(2,7-dihydroxynaphthalene). Therefore, a cured product that does not have Tg in the temperature range from room temperature to 350° C. and achieves both high heat resistance and low thermal expansion can be obtained. When phenol novolac is used as a curing agent, the 5% weight loss temperature of a cured product increases by about 30° C., and the cured product not only has desired Tg but also has good thermal stability at high temperatures.

### EXAMPLES

The present invention will be specifically described by way of Examples and Comparative Examples. The melt viscosity at 150° C., softening point, melting point, GPC, NMR, and MS spectrum were measured under the following conditions.

1) Melt viscosity at 150° C.: measured with the following device according to ASTM D4287.

Device name: MODEL CV-1S available from Codex Corporation

3) Melting point: measured with a simultaneous thermogravimetric analyzer (TG/DTA6200 available from Hitachi High-Tech Science Corporation)

Measurement Conditions

Measurement temperature: room temperature to 300° C.

Measurement atmosphere: nitrogen

Heating rate: 10° C./min

4) GPC: the measurement conditions were as described below.

Measuring device: Shodex “GPC-104”

Column: Shodex “KF-401HQ”
Shodex “KF-401HQ”
Shodex “KF-402HQ”
Shodex “KF-402HQ”

Detector: RI (differential refractive index detector)

Data processing: “Empower 2” available from Waters Corporation

Measurement conditions: column temperature 40° C.

Mobile phase: tetrahydrofuran

Flow rate: 1.0 ml/min

Standard: (polystyrene used)

“Polystyrene Standard 400” available from Waters Corporation

“Polystyrene Standard 530” available from Waters Corporation

“Polystyrene Standard 950” available from Waters Corporation

“Polystyrene Standard 2800” available from Waters Corporation

Sample: 1.0 mass % (on a resin solids basis) microfiltered solution in tetrahydrofuran (50 μL).

5) NMR: NMR LA300 available from JEOL Ltd. Solvent: acetone-d6

6) MS: gas chromatograph time-of-flight mass spectrometer JMS-T100GC available from JEOL Ltd.

Ionization mode: FD

Cathode voltage: −10 kV

Emitter current: 0 mA→40 mA [25.6 mA/min.]

Solvent: tetrahydrofuran

Sample concentration: 2%

### Synthesis Example 1

(Synthesis of 3,3′,5,5′-Tetramethoxy Biphenyl)

A flask equipped with a thermometer, a stirrer, and a reflux condenser was charged with 100 g (0.46 mol) of 1-bromo-3,5-dimethoxybenzene and 472 g of dimethylformamide while the flask was purged with nitrogen gas. After air in the reactor was replaced with nitrogen under stirring, 289 g (4.54 mol) of iodine-activated copper powder was added to the reactor, followed by heating to reflux for 15 hours. To the reaction liquid were added 1 L of ethyl acetate and 1 L of a 1 N aqueous solution of hydrochloric acid. The mixture was transferred to a separating funnel. After an organic phase was separated, an aqueous phase was further extracted with ethyl acetate. The combined organic layers were washed with water and saturated saline. After the solvent was distilled off under vacuum, the residue was dissolved in 300 mL of toluene and allowed to pass through 300 g of silica gel, and silica gel was washed with 1 L of toluene. The obtained toluene solution was distilled off under reduced pressure. A crude product composed mainly of the obtained 3,3′,5,5′-tetramethoxy biphenyl was dissolved in 50 mL of toluene. To the solution, 500 mL of heptane was gradually added, and the precipitated crystal was filtered and dried in a vacuum dryer at 50° C. for 5 hours to obtain 109 g of 3,3′,5,5′-tetramethoxy biphenyl.

### Synthesis Example 2

(Synthesis of 3,3′,5,5′-Tetrahydroxy Biphenyl)

A flask equipped with a thermometer, a stirrer, and a reflux condenser was charged with 100 g (0.36 mol) of 3,3′,5,5′-tetramethoxy biphenyl obtained in Synthesis Example 1, 489 g (3.26 mol) of sodium iodide, and 682 g of acetonitrile while the flask was purged with nitrogen gas. To the mixture, 356 g (3.26 mol) of chlorotrimethylsilane was quickly added dropwise, and the mixture was refluxed for 20 hours. The reaction liquid was cooled to room temperature, and 500 mL of water was added. Acetonitrile was distilled off under reduced pressure, and 1 L of ethyl acetate was added. The mixture was transferred to a separating funnel. After an organic phase was separated, an aqueous phase was further extracted with ethyl acetate. The combined organic layers were washed with a saturated aqueous solution of sodium hydrogen carbonate and saturated saline. The ethyl acetate solution was concentrated to about 200 mL under reduced pressure. A crystal composed mainly of the precipitated 3,3′,5,5′-tetrahydroxy biphenyl was collected by filtration. To the resulting residue were added 50 mL of ethyl acetate and 150 mL of toluene. The mixture was stirred under heating at 80° C. for 10 minutes. The undissolved precipitate was collected by filtration and dried in a vacuum dryer at 50° C. for 5 hours to obtain 50 g of 3,3′,5,5′-tetrahydroxy biphenyl.

### Example 1

(Synthesis of 3,3′,5,5′-Tetraglycidyloxy Biphenyl)

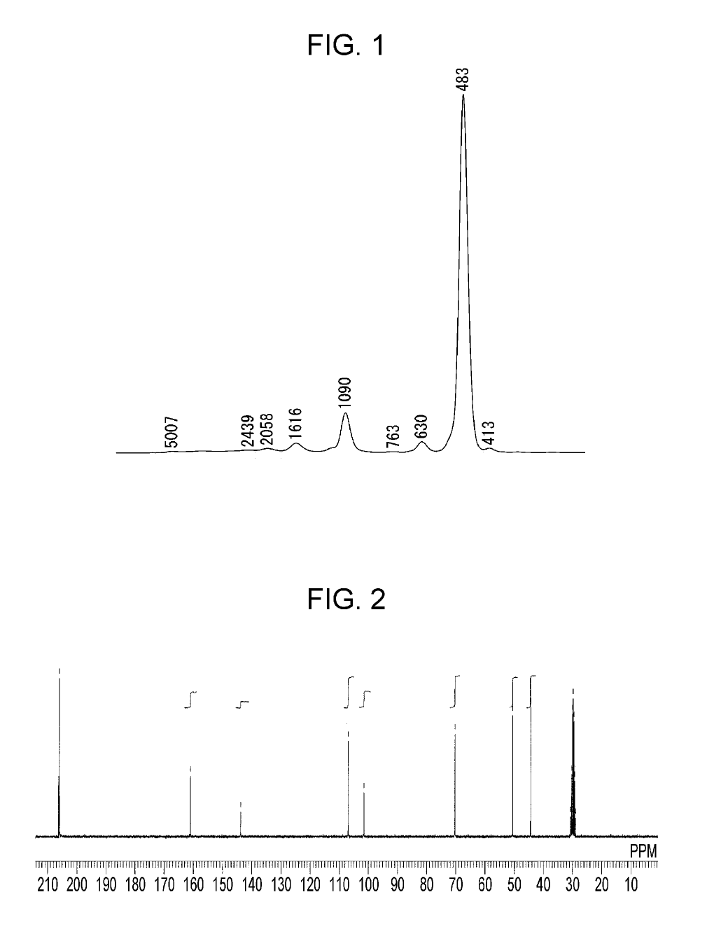

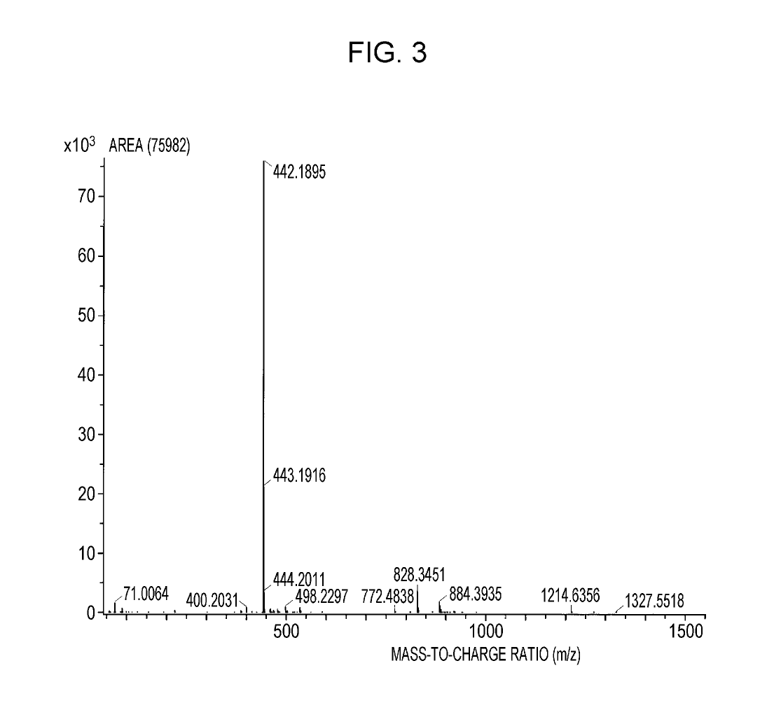

A flask equipped with a thermometer, a dropping funnel, a condenser, and a stirrer was charged with 35 g (0.16 mol) of 3,3′,5,5′-tetrahydroxy biphenyl, 297 g (3.21 mol) of epichlorohydrin, and 104 g of n-butanol to prepare a solution while the flask was purged with nitrogen gas. After the solution was heated to 40° C., 53 g (1.20 mol) of a 48% aqueous solution of sodium hydroxide was added to the solution over 8 hours. Thereafter, the mixture was further heated to 50° C. and further caused to react for 1 hour. After the reaction was complete, 84 g of water was added, the mixture was then allowed to stand, and the lower layer was discarded. Subsequently, unreacted epichlorohydrin was distilled off at 150° C. under reduced pressure. To the resultant crude epoxy resin, 106 g of methyl isobutyl ketone was added to prepare a solution. To this solution was added 67 g of a 10 mass % aqueous solution of sodium hydroxide. The mixture was caused to react at 80° C. for 2 hours and then repeatedly washed with water three times until a washing liquid reached neutral pH. Next, water in the system was removed by azeotropy, followed by microfiltration. The solvent was distilled off under reduced pressure to obtain 60 g of 3,3′,5,5′-tetraglycidyloxy biphenyl (A-1), which was a desired epoxy resin. The resultant epoxy resin (A-1) was a solid having a melting point of 115° C., a melt viscosity of 0.57 dPa·s (measurement method: ICI viscometer method, measurement temperature: 150° C.), and an epoxy equivalent of 121 g/eq. FIG. 1 illustrates a GPC chart of the resultant epoxy resin, FIG. 2 illustrates a C13 NMR chart, and FIG. 3 illustrates a MS spectrum. In the MS spectrum, the peak at 442 indicating 3,3′,5,5′-tetraglycidyloxy biphenyl (A-1) was detected.

### Examples 2 to 3 and Comparative Examples 1 to 4

The following components were mixed at the compositions shown in Table 1: the epoxy resin (A-1) of the present invention obtained in Example 1 or a comparative epoxy resin, namely, a 3,3′,5,5′-tetramethyl-4,4′-biphenol-type epoxy resin (A-2), which was a bifunctional epoxy resin, or naphthalene-type tetrafunctional epoxy resin HP-4700 (available from DIC Corporation) (A-3); phenol novolac-type phenolic resin TD-2131 (available from DIC Corporation, hydroxyl equivalent; 104 g/eq), which was a curing agent; and triphenylphosphine (TPP) or imidazole (2E4MZ (available from Shikoku Chemicals Corporation), which was a curing accelerator. The cured products formed from the mixtures under the following curing conditions (I) or (II) were evaluated for their heat resistance and coefficient of linear expansion. The properties of the epoxy resins and the properties of the cured products are shown in Table 1.

<Curing Conditions (I)>

Each of the mixtures was poured into a mold of 11 cm×9 cm×2.4 mm, and molded by pressing at a temperature of 150° C. for 10 minutes. The molding was taken out of the mold and then cured at a temperature of 175° C. for 5 hours.

<Curing Conditions (II)>

Each of the mixtures was poured into a mold of 6 cm×11 cm×0.8 mm, and precured at a temperature of 110° C. for 2 hours. The molding was taken out of the mold and then cured at a temperature of 250° C. for 2 hours.

<Heat Resistance (Glass Transition Temperature; Tg (DMA)>

A temperature at which a change in elastic modulus was maximized (the rate of change in tanδ was maximized) was evaluated as a glass transition temperature by using a viscoelasticity analyzer (DMA: solid viscoelasticity analyzer RSA II available from Rheometrics Inc., rectangular tension method; frequency 1 Hz, heating rate 3° C./min).

Measurement temperature: 30° C. to 350° C.

<Heat Resistance (5% Weight Loss Temperature)>

The 5% weight loss temperature was measured by using a simultaneous thermogravimetric analyzer (TG/DTA6200 available from Hitachi High-Tech Science Corporation).

Measurement Conditions

Measurement temperature: room temperature to 500° C.

Measurement atmosphere: nitrogen

Heating rate: 10° C./min

<Coefficient of Linear Expansion>

Thermomechanical analysis was performed in a tensile mode by using a thermomechanical analyzer (TMA: TMA-50 available from Shimadzu Corporation).

Measurement Conditions

Load: 1.5 g

Heating rate: 10° C./min for two times

Measurement temperature range: 50° C. to 300° C.

Measurement under the above conditions was performed two times for each sample, and the mean coefficient of expansion in the temperature range of 25° C. to 250° C. in the second measurement was evaluated as a coefficient of linear expansion.

TABLE 1

| | | | | Comparative | Comparative | Comparative | Comparative |
|---|---|---|---|---|---|---|---|
| | | Example 2 | Example 3 | Example 1 | Example 2 | Example 3 | Example 4 |
| Epoxy | A-1 | 54 | 100 | | | | |
| resin | A-2 | | | 65 | 100 | | |
| | A-3 | | | | | 62 | 100 |
| Properties | softening | 115 | 115 | 105 | 105 | 91 | 91 |
| of epoxy | point (° C.) | (melting | (melting | (melting | (melting | | |
| resin | | point) | point) | point) | point) | | |
| | 150° C. melt | 0.6 | 0.6 | 0.2 | 0.2 | 4.5 | 4.5 |
| | viscosity | | | | | | |
| | (dPa · s) | | | | | | |
| Curing | TD-2131 | 46 | | 35 | | 38 | |
| agent | | | | | | | |
| Curing | TPP | 1 | | 1 | | 1 | |
| accelerator | 2E4MZ | | 2 | | 2 | | 2 |
| Physical | Tg (DMA) | 239 | less | 150 | 193 | 236 | — |
| properties | 5% weight | 404 | 395 | 353 | 365 | 378 | — |
| of cured | loss | | | | | | |
| product | temperature | | | | | | |
| | (° C.) | | | | | | |
| | coefficient of | 95 | 68 | 144 | 109 | 79 | — |
| | linear | | | | | | |
| | expansion | | | | | | |
| | (ppm) | | | | | | |

| | | | | | | |
|---|---|---|---|---|---|---|
| Curing conditions | (I) | (II) | (I) | (II) | (I) | (II) |
| Result | | | | | | gelled in |
| | | | | | | production of |
| | | | | | | composition |

### INDUSTRIAL APPLICABILITY

The tetrafunctional biphenyl-type epoxy resin having a symmetrical structure has low melt viscosity, and the cured product thereof has good heat resistance and low thermal expansion.

1. An epoxy resin comprising a 3,3′,5,5′-tetraglycidyloxy biphenyl skeleton represented by formula (1) below:

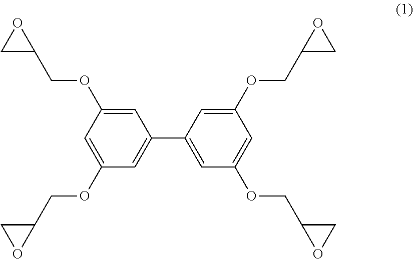 [SMILES: c1c(OCC2CO2)cc(-c2cc(OCC3CO3)cc(OCC3CO3)c2)cc1OCC1CO1]

2. A method for producing an epoxy resin, the method comprising causing a compound having a 3,3′,5,5′-tetrahydroxy biphenyl skeleton to react with epihalohydrin.

3. An epoxy resin obtained by the production method according to claim 2.

4. An epoxy resin composition comprising the epoxy resin according to claim 1 and a curing agent or a curing accelerator.

5. A cured product formed by curing the epoxy resin composition according to claim 4.

6. An epoxy resin composition comprising the epoxy resin according to claim 3 and a curing agent or a curing accelerator.

7. A cured product formed by curing the epoxy resin composition according to claim 6.
